(19) United States
(12) Patent Application Publication
(10) Pub. No.: US 2011/0043501 A1
(43) Pub. Date: Feb. 24, 2011

(54) Material Simulation Device

(76) Inventor: Tyler Jon Daniel, Tokyo (JP)

Correspondence Address: TYLER DANIEL, DAITA 2-2-19, WHITE ROOM 105, SETAGAYA-KU, 155-0033, JP

(21) Appl. No.: 12/687,903

(22) Filed: Jan. 15, 2010

Related U.S. Application Data
(60) Provisional application No. 61/145,077, filed on Jan. 15, 2009.
(60) Provisional application No. 61/178,999, filed on May 17, 2009.
(60) Provisional application No. 61/256,263, filed on Oct. 29, 2009.

(51) Int. Cl. G06F 3/038

(52) U.S. Cl. 345/207

(57) ABSTRACT

A material simulation device is described, capable of simulating emissive and non-emissive colored surfaces, both textured and smooth. The material properties being simulated may be controlled electronically, and may be altered rapidly making smooth animation of surface properties possible. A controller receives data from spectral light sensors, processes the data, and modulates the output of one or more display elements to control the amount of light emitted at a surface of the device. The sum of light from the display elements and light from the environment reflected from the surface of the device matches the amount of light reflected from a real surface with the material properties being simulated.

### CROSS-REFERENCE TO RELATED APPLICATIONS

The application claims the benefit of provisional patent application Ser. No. 61/145,077, filed Jan. 15, 2009, Ser. No. 61/178,999, filed May 26, 2009, and Ser. No. 61/256,263, filed Oct. 29, 2009, all by the present inventor.

### FEDERALLY SPONSORED RESEARCH

Not Applicable

### SEQUENCE LISTING OR PROGRAM

Not Applicable

### BACKGROUND

1. Field of the Invention

The invention relates to the field of display devices generally and more specifically to color- and texture-changing devices.

2. Background of the Invention

The uses of color changing devices may be broadly categorized as relating to either enjoyment or the communication of information. Changing the color of an item to suit personal taste, or displaying a measured temperature by changing the color of an indicator from blue to red, for example. A more complex example is electronic paper, which may be thought of as changing the color of electronically addressable regions of the paper (“pixels”) in order to display an image. Existing devices have serious limitations in the gamut of colors which can be produced, cost of manufacture, lifetime of the device, and durability to name but a few.

Like color-changing devices, a device presenting a surface which appears to change texture would have many uses in entertainment and the communication of information. For example, a portion of a wall near the entrance to a building may show an interactive map to visitors, appearing as a smooth color display, and then appear to fade into and become part of the wall when not in use. However, no such devices exist in the prior art.

### SUMMARY OF THE INVENTION

A material simulation device is described which may be simply and inexpensively implemented. The simplest embodiments include a light source such as a color LED, a diffuser, a color light sensor, and a controller configured to modulate the output of the light source in response to changes in the environment as measured by the color light sensor. More complex embodiments comprise an electronically controlled image projection device as a light source, a diffusing surface, an imaging device to measure light incident on the diffusing surface, and a controller such as a computer configured to modulate the output of the image projection device using data from the imaging device. In both cases material simulation on a surface of the device is achieved by carefully controlling light output such that the sum of light from the environment reflected from the surface of the device and light from the internal light source matches the amount of light that would be reflected by a material having properties being simulated. Additional embodiments are described which change both color and texture in response to signals from a controller.

### BRIEF DESCRIPTION OF THE DRAWINGS

The invention will now be described, by way of example, with reference to the accompanying drawings, wherein:

FIG. 1 shows a diagram of a typical embodiment of the present invention.

FIG. 2 shows a cross-sectional view of a material simulation device.

FIG. 3A shows a top-view of an embodiment using touch sensor data to simulate shadows.

FIG. 3B illustrates sample touch sensor data for the configuration of FIG. 3A.

FIG. 4A shows a close-up, cross-sectional view of a self-shadowing, undulating surface.

FIG. 4B shows a top view of an embodiment which simulates textured surfaces.

FIG. 4C shows data from a directional spectral sensor.

FIG. 5A is a cross-sectional view of a material simulation device which employs a normalizing part comprising transparent and opaque regions.

FIG. 5B is a top view of a sample distribution of transparent and opaque regions of part 250.

FIG. 6 is a cross-sectional view of a waveguide-based material simulation device.

FIG. 7 is a top view of a keypad comprising multiple material simulation devices.

FIG. 8 is a top view of a multi-colored overlay.

FIG. 9 is a diagram of a GUI for display on a material simulation display.

FIG. 10 is a cross-sectional view of a color-changing device with a diffuser part 270 of non-uniform thickness.

FIG. 11 shows a user interface embodiment of the present invention.

### DETAILED DESCRIPTION

Turning to the drawings in detail, in which like reference numerals indicate the same or similar elements in each of the several views.

### DEFINITIONS AND ABBREVIATIONS

self-luminous—a surface which emits light regardless of irradiance from the environment.

emissive—self-luminous.

color display—a display comprising more than one display element or pixel, whose color may be configured by a controller. May be emissive and/or reflective.

SPD—Spectral Power Distribution

spectral sensor—a sensor which measures aspects of the SPD of light. A simple spectral sensor might comprise, for example, two monochromatic light sensors having different spectral responses. One type of commonly available spectral sensor is a Red/Green/Blue (RGB) color sensor. One example of a more complex spectral sensor is a spectrometer sensitive to visible light. Still another type comprises a single photosensor with a spectral response approximating the human perception of brightness.

color light sensor—spectral sensor

pixel—a pixel element, referring to parts of a display or display surface with an emissivity, reflectivity, color, or some other visible property which can be modulated by a controller.

light—electromagnetic energy of any wavelength

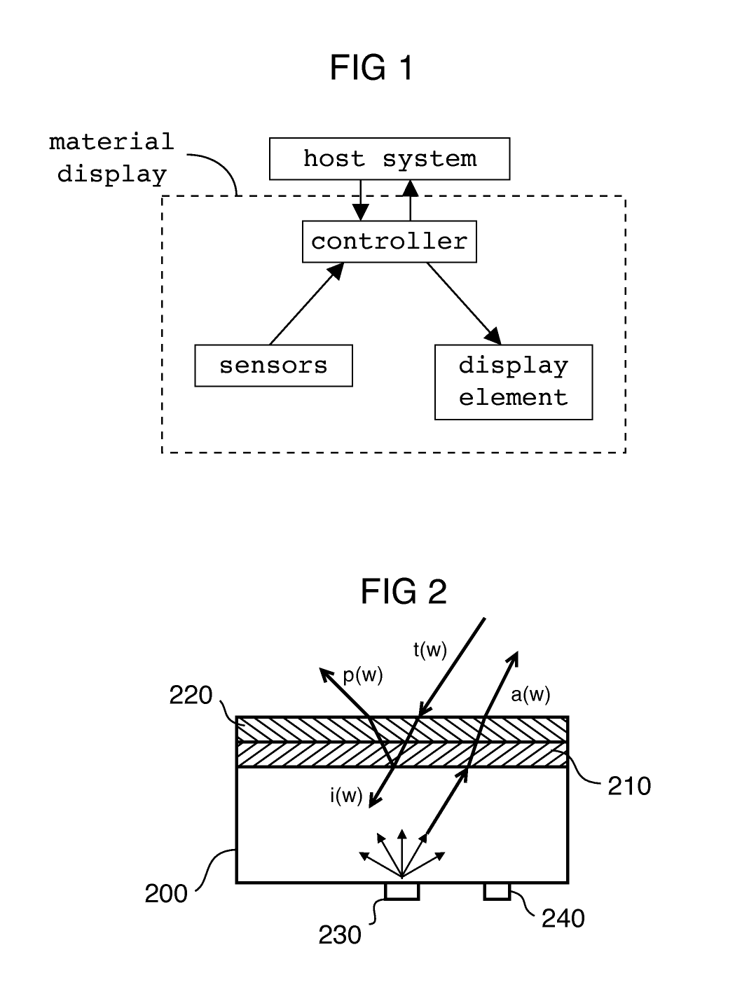

FIG. 1 is a diagram of the components in a material display system according to aspects of the present invention, with arrows representing the flow of information. A host system communicates information including material properties to a controller, and optionally receives from the controller information about the state of the sensors. Sensors measure information about the environment, including the amount of light incident on the display surface. A display element having a display surface comprises a light emissive or reflective element or elements, the emissive or reflective properties being modified by the controller. The controller uses material properties from the host system and measurements from the sensors to compute a control signal sent to the display elements. The control signal causes the display surface to appear to an observer to have the material properties communicated by the host system.

FIG. 2 shows one embodiment of the present invention. A rectangular housing 200 with diffusely reflective internal surfaces is capped by a diffuser 210 and a filter 220. A light source 230 injects light into housing 200 and a spectral sensor 240 is configured to measure light inside housing 200. Light incident on the surface of the device with irradiance t(w), a spectral power distribution (SPD), first passes through filter 220 which selectively absorbs some of the light. Light exiting filter 220 then strikes diffuser 210. Some of the light is reflected back out through filter 220 again and exits the device. The SPD of light originally from the environment reflected by filter 220 and diffuser 210 is given by p(w), a function of wavelength which will be referred to as the “device reflectivity.” Other light passes through both filter 220 and diffuser 210 to enter housing 200 with a SPD given by i(w).

The majority of light from light source 230 exits the device through diffuser 210 and filter 220 with a radiant exitance SPD given by a(w). Diffuser 210 and filter 220 are configured such that light from light source 230 exits the device diffusely at a substantially constant radiance across the surface of the device.

A controller not shown is configured to periodically measure i(w) using spectral sensor 240. The ratio of t(w) to i(w), denoted by R, is constant for the device and computed beforehand and stored in a memory accessible to the controller. Therefore, the SPD of light from the environment present at the surface of the device, t(w), is R*i(w). Both light from the environment (i(w)) and light from light source 230 are present in housing 200 but are distinguished by multiplexing in time such that i(w) is measured while light source 230 is off, by measuring the sum of i(w) and light from light source 230 which has a known SPD and then subtracting, or by any other appropriate means.

The controller is configured to simulate a material having a reflectivity given by m(w), called the “simulated diffuse reflectivity” or just the “simulated reflectivity.” Such a material would reflect light with a SPD v(w)=m(w)*t(w). The SPD of light exiting the device of FIG. 2 is just the sum of the passive and active components p(w) and a(w). p(w) is computed as a function of t(w) using a constant relationship stored in a memory accessible to the controller. Therefore, to simulate a material with reflectivity m(w), the controller adjusts the output of light source 230 (the output of which is just a(w)) such that a(w)+p(w)=v(w). The controller is configured to perform this adjustment preferably at a rate of at least 10 times per second or more preferably at a rate of at least 30 times per second.

Light source 230 may be a multi-channel LED, including red-green-blue (RGB) LEDs such as the NSSM009BT from Nichia. Spectral sensor 240 may be a spectrometer, colorimeter, or multi-channel photosensor including three-channel red-green-blue color sensors such as the Hamamatsu Photonics S9706 digital color sensor. For the purpose of calculations by the controller, the SPDs may be represented as RGB triplets or any other vector of coefficients of basis functions approximating the actual SPD over the visible range. Alternatively, all quantities may be converted to an intermediate color space including CIE XYZ, CIE Yuv, CIE L*u*v*, or CIE L*a*b* for calculations using appropriate device profiles.

Filter 220 may be any appropriate type of filter including dyed filters, pigmented filters, half-tone type filters, and polarizing filters. Suitable materials for diffuser 210 include pigmented, transparent polymers and many other materials known to those skilled in the art.

The inner surfaces of housing 200 may be diffuse and/or specular reflectors.

The simulated reflectivity may be selected by the user from a set of colors stored in the controller, or may be communicated to the controller from a host system or other user interface device.

Another embodiment of the general form of FIG. 1 and similar to that of FIG. 2 comprises a color display with a display surface comprised of multiple pixels corresponding to the display element of the previous embodiment. Each pixel comprises one or more light sources and a spectral sensor. A controller receives diffuse reflectivity values to simulate for each pixel from a host system and measures t(w) (the amount of light from the environment incident at each pixel) using the spectral sensors. As before, the device reflectivity p(w) is known a priori, and the controller adjusts a(w) for each pixel such that a(w)+p(w)=v(w), where v(w)=m(w)*t(w). A display incorporating spectral sensors in each pixel is described, for example, in U.S. patent application Ser. No. 11/176,393, which is incorporated herein by reference.

Further embodiments also employ a color display comprised of pixels as the display element, but each pixel comprises only a light source, not a spectral sensor. t(w) is assumed to be approximately constant over the display surface and is measured by a spectral sensor mounted proximal to the display surface.

Still further embodiments comprise multiple spectral sensors arranged around the periphery of the display surface. t(w) for each pixel is computed by the controller as a linear interpolation of the measurements of each spectral sensor according to the pixel's position relative to each spectral sensor.

Yet other embodiments employ an imaging device such as a camera configured to image the display surface and measure p(w) or i(w) directly, from which t(w) is computed.

Further embodiments employ a projector and projection surface as a display element.

The display surfaces of these and other embodiments preferably emit or reflect light in a lambertian fashion, which results in brightness approximately constant with respect to viewing angle, as is the case with many physical materials. Many electro-luminescent (“organic LED”) displays and front projection systems have approximately lambertian radiance, as do most CRTs. Many liquid crystal displays (LCDs) are designed with highly non-lambertian radiance, but this is a design decision rather than a limitation of the technology. Recent LCD technologies including IPS, S-IPS, and VA pixel structures allow for good contrast and color reproduction over a wide viewing field, and when combined with a lambertian backlight are suitable for use in the present invention.

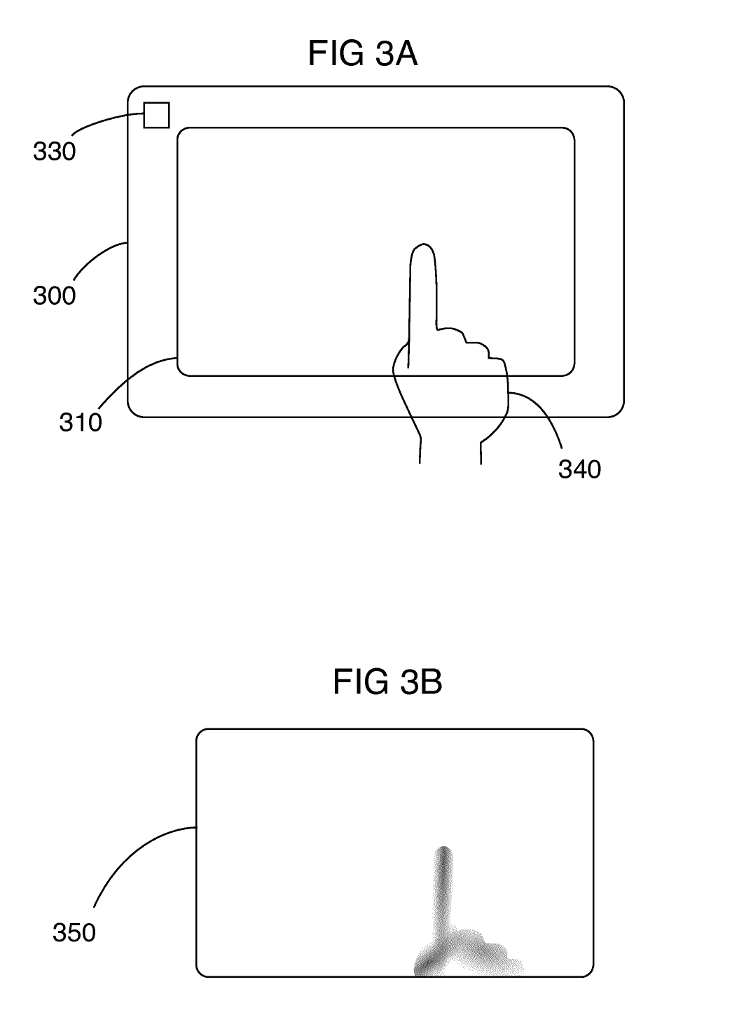

A further embodiment is shown in FIG. 3A. A color display 300 comprising multiple pixels forms the display element of the system, and provides a display surface 310. Display 300 is configured with a touch sensor 320 (not shown) covering display surface 310. Touch sensor 320 provides data 350 to a controller of the form illustrated in FIG. 3B, where darker shading indicates closer proximity of an object to display surface 310. This type of data is typical of commonly available capacitive and optical touch sensors. An operator's hand 340 is shown touching display surface 310.

A spectral sensor 330 is provided proximal to and in the plane of display surface 310. A controller computes t(w) for each pixel of display surface 310 by interpolating irradiance data from spectral sensor 330 as described for previous embodiments. For each pixel, the controller then modifies t(w) by modulating with a coefficient derived from data 350. The coefficient is just the value of data 350 at the location of the each pixel, where 0 represents physical contact with display surface 310 and 1 represents nothing detected by touch sensor 320. In this manner, the shadow of hand 340 which is not detected by spectral sensor 330 is approximated using data 350 to give a more realistic appearance of a material simulated by the system.

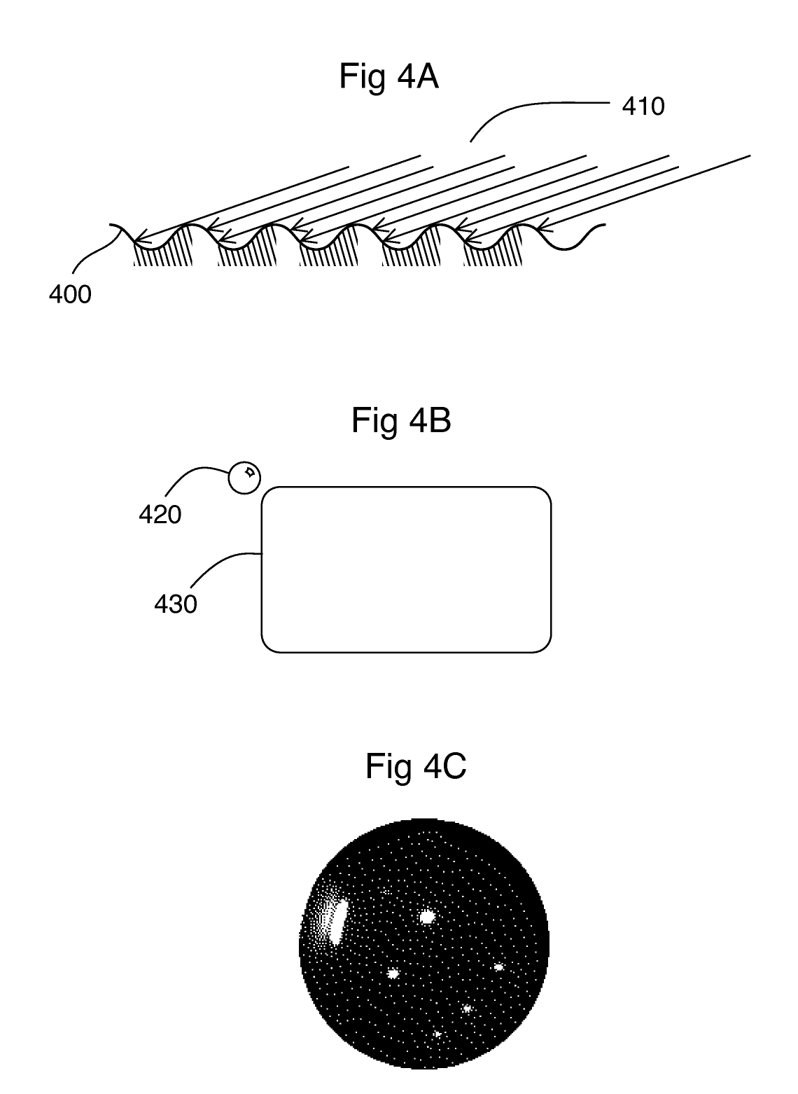

FIG. 4 shows a cross-section of a textured surface 400. “Textured” is used herein to denote surface deformations whose scale is small relative to the surface area. Materials with little texture are referred to as “smooth materials.” Polished plastic and finished wood are examples of real-world smooth materials. Physical examples of textured materials include canvas and most other types of cloth, unfinished wood, and bricks and mortar. Whereas preceding embodiments have been primarily concerned with the simulation of smooth materials, further embodiments simulate textured materials.

The visual appearance of a material is strongly dependent on texture largely because of self-shadowing effects. Surface 400 is illuminated by light 410 incident at an oblique angle. The shaded regions show areas of shadow, which give surface 400 a visual appearance distinct from that of a smooth surface of the same color. The size of the shadowed regions Is determined by the angle at which light strikes surface 400.

A further embodiment capable of simulating both the color and texture of a physical material is shown in FIG. 4B. A controller receives from a host system parameters of the material to be simulated, including a three-dimensional (3D) description of the material texture in addition to material color data as in previous embodiments.

A directional spectral sensor 420 is configured to receive light incident on a display surface 430 and provide data 440 to the controller. A “directional spectral sensor” is a sensor which measures spectral information of light coming from specific directions. Sensor 420 comprises an image sensor and lens unit configured with a 180-degree field of view (FOV). An example of actual data (reduced to bi-tonal black and white) from such a directional spectral sensor is provided in FIG. 4C. Each data point (“pixel”) of data 440 represents the amount of light incident on sensor 420 from a certain direction. Together, the data points of data 440 cover a hemisphere.

The interaction of the material as described by parameters from the host system and incident light measured by sensor 420 is simulated using a global illumination algorithm. Suitable algorithms are described in U.S. patent Ser. Nos. 10/951,272 to Snyder and 10/815,141 to Sloan, and U.S. patent application Ser. No. 11/089,265 to Snyder, all of which are hereby incorporated herein by reference. The process is summarized as follows.

The 3D material texture description and other material parameters are processed by the controller to produce a hemispherical function Y(d) for each pixel of the display area, encoded in a spherical harmonic basis. For a direction d, Y(d) gives the amount of light incident from direction d diffusely reflected from the material at the associated pixel. Y(d) encodes material-light interactions including self-shadowing, sub-surface scattering, and multiple reflections. Y(d) need be computed only once for a given set of material parameters.

The controller then computes for each data set acquired from sensor 420 a spherical harmonic approximation E(d) of the data 440. Finally, the controller computes for each pixel of the display surface the dot product P of the basis coefficient vectors of Y(d) and E(d), yielding the amount of light diffusely reflected at the pixel. P is the amount of light which would be reflected by a material of the given parameters in the current lighting environment. The display surface has a diffuse reflectance R, a fixed property of the display. The controller computes a quantity P−R*T, where T is the irradiance t(w) incident on the display surface, which is the output signal used to drive the associated pixel. T is obtained by integrating data 440 or alternatively by providing a second spectral sensor as described in previous embodiments.

In further embodiments, Y(d) is a vector function with one component each for multiple spectral regions which are separately simulated, for example red, green and blue components yielding a vector P with three components red, green and blue. A directional spectral sensor with multiple channels for each pixel (for example, a RGB color imaging device) may be used to acquire a multi-valued irradiance map, or a multi-channel, non-directional spectral sensor may be provided in addition to the directional spectral sensor. In the latter case, the vector of data from the non-directional spectral sensor is multiplied with E(d) to produce a vector version of E(d).

In still other embodiments, a reflective type color display is used as the display element.

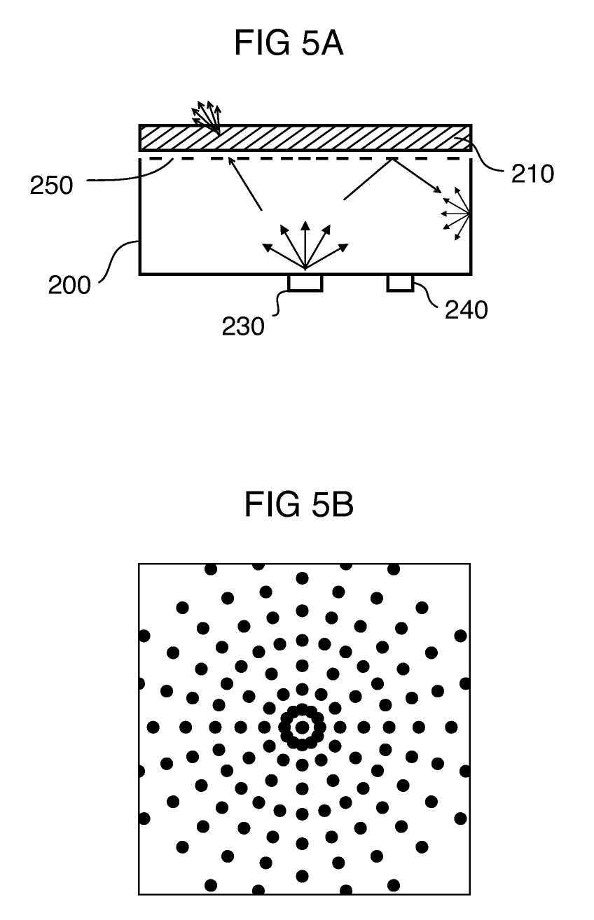

A further embodiment is shown in cross-section in FIG. 5A. This embodiment is similar to that of FIG. 2 except that filter 220 has been replaced by a part 250 placed on the opposite side of diffuser 210. Part 250 comprises opaque regions, shown in black, and transparent regions. A top view of part 250 is shown in FIG. 5B. The opaque regions are highly reflective on the side facing light source 230 and less reflective (dark or black) on the opposite side. The density of the opaque regions is greatest directly above light source 230 and least furthest away from light source 230. The size of the transparent regions has been exaggerated for illustrative purposes and in reality is very small, preferably with a largest dimension of 2 mm. The distribution of the transparent regions has also been simplified for illustrative purposes. The distribution of transparent regions is arranged such that light from light source 230 exits the embodiment through the transparent regions and diffuser 210 with approximately constant radiance across the surface of the device. Such an arrangement is well known to those skilled in the art of optical design; a related device is described, for example, in U.S. patent application Ser. No. 12/087,800, which is incorporated herein by reference.

Light striking an opaque region on the side of part 250 facing light source 230 will be reflected or “recycled” back into housing 200. Other light from light source 230 or a surface of housing 200 striking a transparent region of part 250 will exit the device through diffuser 210. Light from the environment striking an opaque region on the side of part 250 opposite light source 230 will be largely absorbed. In this manner reflections from the surface of the device are reduced without absorbing light from light source 230, as is the case in the embodiment of FIG. 2.

Light source 230 and spectral sensor 240 are shown on the face of housing 200 opposite the exit face, but additional embodiments place light source 230 and spectral sensor 240 on other, not necessarily the same, faces.

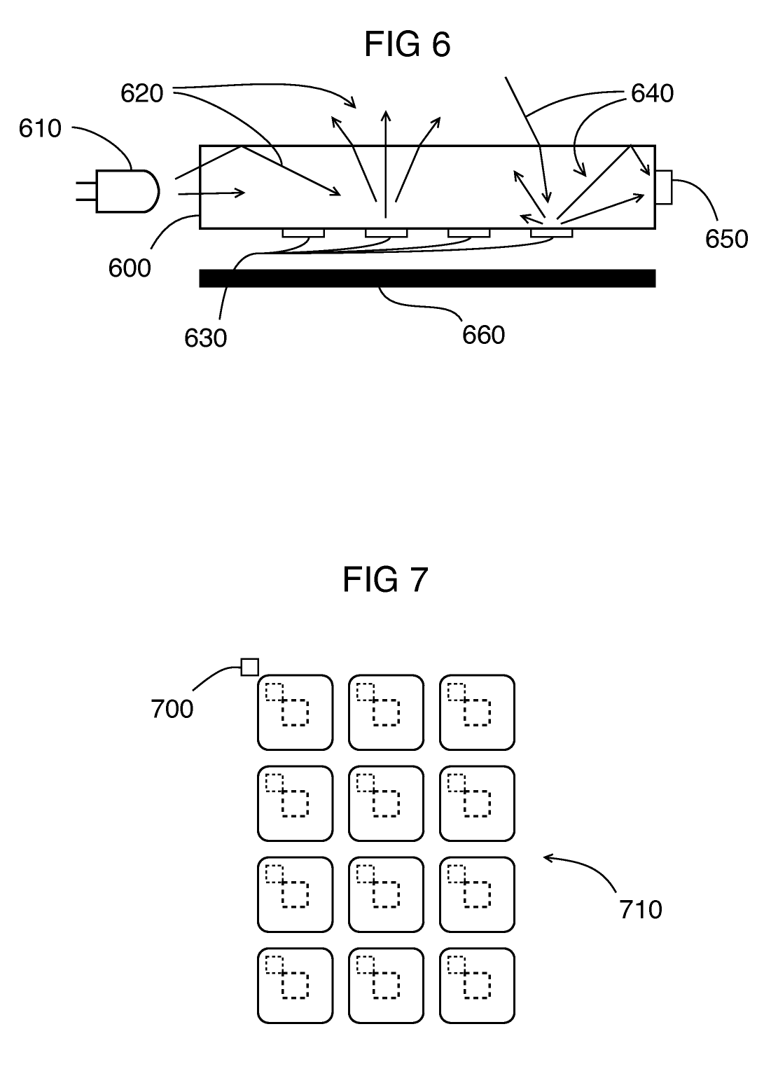

Still another embodiment is shown in simplified cross-section in FIG. 6. As in previous embodiments, a controller receives signals from a spectral sensor 650 and drives a light source 610. Light 620 from light source 610 enters a waveguide 600 and propagates by internal reflection, eventually striking a reflector dot 630. Reflector dots 630 comprise diffusely reflective material bonded to waveguide 600 and cause part of light 620 to exit waveguide 600. Such a configuration is common in backlight design and many variations will be known to a skilled practitioner. Light 640 from the environment enters waveguide 600 and is diffusely reflected by dots 630 and then travels to spectral sensor 650. In this manner spectral sensor 650 measures light from the environment without being directly visible to a user of the device. A planar sheet 660 of similar dimensions to waveguide 600 is provided parallel and proximal to waveguide 600. Sheet 660 absorbs part or most of light from the environment which travels through waveguide 600 and reaches 660. In a conventional backlight design sheet 660 comprises a highly reflective material, but for the present invention it is desirable to reflect only part of light from the environment while minimizing absorption of light emitted by light source 610.

Still other embodiments mount sensor 650 so that it receives light directly from the environment as in previous embodiments, with its light receiving surface parallel to the plane of waveguide 600.

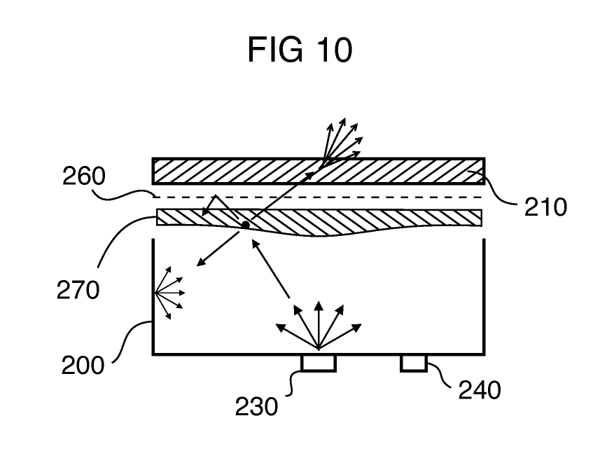

Still another embodiment is shown in FIG. 10, similar to that of FIG. 5A and differing only in the method of providing uniform illumination at the display surface. Light from light source 230 strikes a part 270 comprising a diffusing material and scatters internally multiple times. Some light exits part 270 and re-enters housing 200 where it is again reflected from the internal faces. Other light exits part 270 and strikes part 260 and is reflected back towards part 270. Other light exits part 270 and passes through a transmissive region of part 260 to strike diffuser 210 and exit the device.

Part 260 is similar in construction to part 250 of FIG. 5A except that opaque and transparent regions are evenly distributed. The lower face of part 260 as shown in FIG. 10 is highly reflective, whereas the upper face is less reflective.

Part 270 is thickest at points closest to light source 230 and causes light to exit part 270 in the direction of part 260 with an approximately constant radiant exitance.

FIG. 10 is an exploded view; parts 270 and 260 and diffuser 210 are situated either in close proximity with an air gap or bonded together.

Suitable materials for the construction of part 270 including transparent polymers containing voids (foams) or particles of reflective material including barium sulfate and titanium dioxide. Part 260 may comprise a solid material with voids forming the transparent regions or a transparent substrate with an opaque coating.

Yet another embodiment is similar in structure to that of FIG. 10 excepting parts 260 and 270. Part 270 has a constant thickness and acts only to produce a lambertian, non-uniform exitance in the direction of part 260. Part 260 has a non-uniform distribution of opaque and transparent regions which result in a uniform, lambertian radiant exitance in the direction of diffuser 210.

Still other embodiments provide modes of operation in which the controller, upon receiving commands from the host system, controls the display element such that it emits more light than a passive material would in at least one region, causing that region to appear to glow.

Multiple devices may be combined into a single consumer device, for example forming buttons on a mobile phone keypad. Each device (button) may be individually controlled such that patterns of different colors may be displayed on the device. The colors displayed may be controlled by the host system to reflect device state or convey information. Such an embodiment is illustrated in FIG. 7.

A spectral sensor 700 measures t(w), the amount and spectral content of light incident on the plane defined by buttons 710. Each button has a structure similar to that of FIG. 2, with a light source and spectral sensor shown respectively as large and small dashed squares in FIG. 7. The spectral content of t(w) is assumed to be constant over the surface of the device. The outputs of all button sensors are continuously monitored, and the button with the largest output is assumed to have a local t(w) equivalent to that at sensor 700. All button sensor outputs are normalized by this value such that buttons shadowed by an opaque object (a finger, for example) will have an associated sensor output of less than 1. Computations are carried out as in the embodiment of FIG. 2 using for each button t(w) as measured by sensor 700 modulated by the normalized button sensor output.

While this embodiment comprises structures similar to that of FIG. 2, other embodiments employ different light sources in combination with simple spectral sensors which capture local variations in irradiance, for example the embodiment of FIG. 3A. Suitable light sources include LCDs, organic LED displays, and projected displays.

In the case of multiple devices placed in close proximity, the devices may share a single spectral sensor to measure the SPD of incident light in order to reduce manufacturing cost. In such embodiments, t(w) is assumed to be constant over the surface of the device.

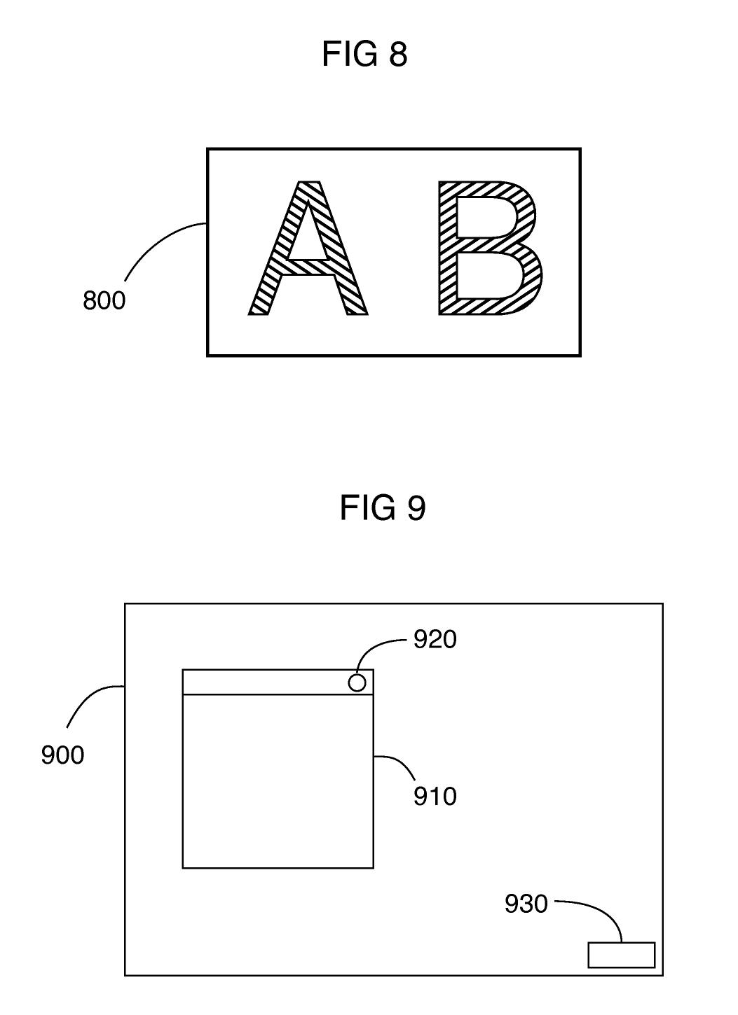

A still further embodiment comprises a display surface whose color may be controlled and an overlay with multiple transparent, colored regions. An example is shown in FIG. 8. Overlay 800 is transparent over the visible range except for two regions A and B. Region A strongly absorbs light of wavelengths 400-500 nm, and is otherwise transparent. Region B strongly absorbs in the region 580-800 nm and is otherwise transparent. Thus, when placed over a “white” surface, region A appears cyan and region B appears yellow. Overlay 800 is placed over the display surface, whose color is modulated. When the display surface is green with a dominant wavelength of 540 nm, the overlay passes almost all light and the surface appears a uniform green color. If the display surface color is then changed to a red color with dominant wavelength 620 nm, region B strongly absorbs while region A remains transparent and a black letter “B” is seen on a red background. If the display color is then changed to a blue color with dominant wavelength of 450 nm, region A strongly absorbs and a black letter “A” is seen on a blue background.

In this manner the display surface forms a label which can be modified by a controller to convey changing information to a user.

Similar embodiments comprise an overlay with opaque, colored regions surrounded by transparent regions. A given opaque region is made to “disappear” by changing the color of the underlying display surface to match the color of the opaque region which then blends into the background.

A further embodiment implements light source 230 using an image projection device and sensor 240 using a color imaging device. The housing of the device is configured to suppress internal reflections. The mapping of projected pixels to imaged pixels (projector and camera pixels, for example) is known to the controller, which uses this information to continuously adjust the projected image according to local lighting conditions measured by the imaging device. This embodiment may be considered a collection of multiple devices as shown in FIG. 2. Where imaged and projected pixels do not have a one-to-one correspondence, lighting conditions as measured by the imaging device and as computed by the controller for the projection device may be interpolated using any appropriate method, including polynomial interpolation.

Still further embodiments monitor the amount of light incident on a display surface along with the amount of light emitted by a light source which is reflected back onto the display surface, as is commonly done for proximity sensors, to yield a value representing the proximity of an object to the device. The proximity data is processed to sense contact with the display surface and provide information to a host system which can be interpreted as button presses or other user interface events. In other embodiments comprising multiple, independent display surfaces, the proximity data forms an image of objects near the display surfaces and can be processed to track position using techniques familiar to a skilled practitioner.

In another embodiment of the present invention, the device of FIG. 2 operates as a reflective color sensor to determine the color of materials placed near the surface of the device (filter 220 and diffuser 210). In this case light from light source 230 exits the device and is partially reflected by the nearby material, re-entering the device where it is measured by color sensor 240. t(w) is measured twice using methods described above, first with light source 230 active (t1(w)), and second with light source 230 inactive (t2(w)). The unknown reflectivity of the nearby material u(w) is then (t1(w)−t2(w))/a(w).

In one mode of operation, the measured reflectivity u(w) is used as the reflectivity to be simulated, effectively “copying” the a material color to the device, much as a chameleon changes its color to match the environment. In another mode of operation, the measured reflectivities are stored in memory for later simulation.

In a further mode of operation, a new reflectivity for simulation is generated to “match” the measured reflectivity, such that the device gives a pleasing appearance when viewed together with the measured reflectivity. The matching reflectivity may be generated using any number of algorithms known to those skilled in the art, including look-up tables (LUTs) created a priori and stored in the device, and choosing the color at a fixed offset angle such as 60 or 90 degrees on a color wheel including the color corresponding to u(w).

FIG. 9 shows a GUI 900 based on a display capable of simulating changing color and texture. GUI elements or “widgets” including a window 910 with button 920 and a message area 930 are displayed. The widgets are normally displayed in a passive mode, simulating the appearance of physical materials. Button 920 is operable by a user operating a pointing device and causes window 910 to toggle between its normal, passive state, and emissive states 1 and 2. Emissive state 1 causes a scale factor greater than 1 to be applied to t(w) as measured by associated spectral sensors which causes window 910 to appear to glow while still showing texture variations with changes in surrounding lighting. Emissive state 2 causes the appearance of window 910 to computed using a t(w) computed from a stored, virtual light source instead of being computed from data based on measurements by associated spectral sensors.

Area 930 has similar emissive modes which are used to draw attention to the area when a new message is ready, in a manner similar to blinking or motion effects which are traditionally used to draw the user's attention.

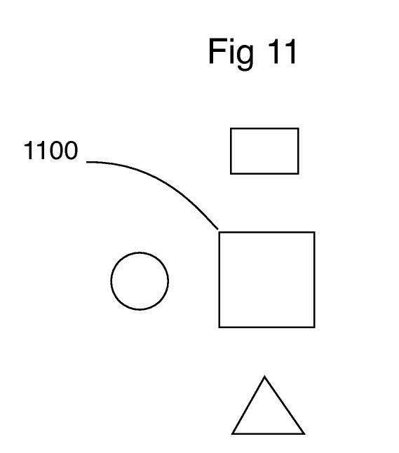

FIG. 11 shows a further user interface embodiment. A color changing user interface element 1100 is located adjacent to colored printed regions on a surface of a consumer electronics device. A controller, not shown, comprising a programmable microcomputer is configured to display the current mode of operation of the consumer electronics device by changing the color of user interface element 1100. The colored printed regions surrounding user interface element 1100 comprise graphics and/or text printed in a primary color indicative of each mode of operation, matching one color displayed by the controller on user interface element 1100. User interface element 1100 may also operate as a button or other input used to change the current mode of operation. For example, if the three printed regions (fascia) may represent operating modes a, b, and c, respectively, and be primarily colored red, green, and blue, respectively. When the device is in operating mode a, the controller configures element 1100 to display red, which a user observes as matching the printed region corresponding to operating mode a. The printed region describes the operating mode to the user via an icon or descriptive text.

Another embodiment of the current invention is a lamp or other lighting device wherein the light emitting element may be in one of three states: off, colored, and lit. In the off mode, the element is dark; in the colored mode, the element displays a color according to any appropriate embodiment of the present invention; in the lit mode the lamp is “turned on” and glowing. In this way the lamp may be set to an attractive color when not in use.

Still further embodiments simulate fluorescent materials. A real, fluorescent material both reflects light and absorbs light and re-emits the absorbed light shifted in wavelength. The visible appearance of the material is a sum of two parts: a non-fluorescent part v(w) as in previous embodiments, and a fluorescent part f(w). f(w) is a function of the material's absorption spectrum ab(w) and its emission spectrum em(w), given by the relationship f(w)=em(w)*∫(ab(w)*t(w)), where t(w) is, as before, the spectral illuminance incident on the material. The SPD of light seen to be coming from the surface of the device is, as before, a(w)+p(w). A controller is configured to adjust a(w) such that a(w)+p(w)=v(w)+f(w), preferably at a rate of at least 10 times per second.

Still further embodiments comprise sensors which measure the absorption spectrum ab(w) and emission spectrum em(w) of a real material, and communicate ab(w) and em(w) to a controller configured to simulate fluorescent materials as in previous embodiments. A fluorescence spectrometer is one example of such a sensor.

### EXAMPLE IMPLEMENTATION

A prototype unit was constructed according to embodiments of the present invention with a basic construction similar to that of FIG. 2. A MSP430F169 microcontroller from Texas Instruments was programmed with instructions implementing both a controller and a host system. Previously mentioned LED NSSM009BT and sensor S9706 were used as a light source and spectral sensor, respectively.

The spectral sensor measures light in a color space denoted by EFG, and the led color space is denoted by UVW. The CIE XYZ color space is used for intermediate calculations.

The system simulates a material having a diffuse reflectivity described by a triplet m, which is derived from the spectral sensor measurements of a physical material under a fixed, arbitrary illumination (a white LED). The measurements are normalized against measurements of a white surface under identical illumination, giving the triplet m.

A triplet uvw defining PWM duty cycles used to drive the red, green, and blue components of the LED is derived from m, a triplet illumEfg, and two 3×3 matrix transforms materialToUvw and illumEfgToUvw. illumEfg represents t(w) and is derived from a measurement of i(w) by spectral sensor 240 by multiplying i(w) by a constant equal to t(w)/i(w).

illumEfgToUvw is computed as follows. n measurements of various lighting environments are taken using both spectral sensor 240 and a spectrometer. The spectrometer measurements are converted to XYZ space triplets. If A is a 3×n matrix whose columns are the XYZ spectrometer measurements and B is a 3×n matrix whose columns are the EFG spectral sensor 240 measurements, then a 3×3 matrix illumEfgToXyz is given by A=illumEfgToXyz*B. illumEfgToUvw is just illumEfgToXyz followed by a color space conversion from XYZ to LED color space UVW.

materialToUvw is computed as follows for a given lighting environment. The SPD of the lighting and the light reflected from several physical material samples are measured with a spectrometer and converted to XYZ triplets S and r₀ . . . rₙ, respectively. The same material samples are measured using spectral sensor 240 and a white led as described above to yield triplets m₀ . . . mₙ. A triplet A is computed for each material measurement from the equation Aᵢ=rᵢ/S, where/represents component-wise division. A 3×3 matrix transform materialToXyz represents a mapping from material measurements m to triplets A, and is given by AA=materialToXyz*mm, where AA is a 3×n matrix whose columns are A₀ . . . Aₙ, and mm is likewise a 3×n matrix whose columns are m₀ . . . mₙ. materialToUvw is just materialToXyz followed by a color space conversion from XYZ to LED color space UVW.

Several transforms materialToUvw are computed offline for different lighting environments (i.e., fluorescent, incandescent, daylight, etc.) and stored in the microcontroller memory along with a triplet representing the EFG color of the lighting. At runtime the transform whose associated EFG triplet is closest to the current illumination is used.

A triplet illumUvw is given by illumEfgToUvw*illumEfg. Finally, uvw is illumUvw*(materialToUvw*m)−illumUvw*P, where P is p(w), the passive diffuse reflectivity of the device.

### CONCLUSION

Thus many devices and methods are provided to implement color changing devices in a convincing and inexpensive manner.

Patents, patent applications, or publications mentioned in this specification are incorporated herein by reference to the same extent as if each individual document was specifically and individually indicated to be incorporated by reference.

While the above description contains many specificities, these should not be construed as limitations on the scope of the invention, but rather as exemplifications of preferred embodiments of the invention. Many other variations are possible.

What is claimed is:

1. A material simulation device comprising:
a display surface;
one or more spectral light sensors configured to receive light incident upon said display surface;
one or more display elements configured to emit light from said display surface in the direction of a viewer;
and a controller configured to receive data from said spectral light sensors and to modulate light output from said display elements according to the equation v(w)=a(w)+p(w).
